(19) United States
(12) Patent Application Publication
(10) Pub. No.: US 2017/0190083 A1
(43) Pub. Date: Jul. 6, 2017

(54) IN MOLD FORMING OF AN INDICATOR PANEL AND ARTICLES THEREOF

(71) Applicant: SABIC Global Technologies B.V., Bergen op Zoom (NL)

(72) Inventors: Quan Zhou, Shanghai City (CN); Yi Li, Shanghai (CN); Matthew Michael Laurin, San Pedro, CA (US); Wei Yan, Kunshan City, Jiangsu Pro. (CN); Wibowo Harsono, People's Republic (CN); Jeffrey Eshenaur, Hamilton, MI (US)

(21) Appl. No.: 15/315,761

(22) PCT Filed: Jun. 1, 2015
(86) PCT No.: PCT/US2015/033456

§ 371 Date: Dec. 2, 2016

Related U.S. Application Data
(60) Provisional application No. 62/007,589, filed on Jun. 4, 2014.

(51) Int. Cl. B29C 45/16; B29C 45/00; B29C 45/14

(52) U.S. Cl. CPC B29C 45/16; B29C 45/14; B29C 45/00

(57) ABSTRACT

A method of manufacturing can comprise: introducing a first polymeric material to a mold, wherein the first polymeric material resists metallization; introducing a second polymeric material to the mold, wherein the second polymeric material accepts metallization; molding an article from the first polymeric material and the second polymeric material, wherein the second polymeric material extends along a surface portion of the article; coupling a metallic material to the surface portion of the article to form a part having a metallic surface finish by exposing the article to the metallic material in a metallizing process, wherein the metallic material is not coupled to the first polymeric material.

### BACKGROUND

Vehicle manufacturers can differentiate their products in the global market by reducing the cost and weight of vehicle components and improving vehicle styling in order to provide more value to their customers. An approach to reducing component weight, and improving fuel economy, can be to replace heavy materials with lighter ones, e.g., replace metal with plastic. The raw material cost and the cost of processing a raw material into a finished part can establish a minimum cost for a vehicle component. One path to reduce part cost can be to minimize processing cost. Manufacturers can reduce processing cost through automation, integrating manufacturing operations, increasing efficiency of operations, and/or reducing the number of manufacturing operations. Reducing the number of component assembly operations can be a target area for cost reduction. Reducing the amount of metal used in vehicle components, or eliminating metal, can reduce component weight. An area of opportunity can be in the manufacture of components having metallic surface finishes (e.g., chrome accents), such as logos, grilles, trims, door handles, badges, emblems, decorative accents, indicator panel accents, dashboard accents, and the like. Another area of opportunity can be in the manufacture of indicator panels which can include multiple molding operations.

Accordingly, a need exists to reduce the cost and/or weight of vehicle components while providing unique styling opportunities, without diminishing the functional quality, aesthetic quality, and/or durability of the component.

### SUMMARY

A method of manufacturing can comprise: introducing a first polymeric material to a mold, wherein the first polymeric material resists metallization; introducing a second polymeric material to the mold, wherein the second polymeric material accepts metallization; molding an article from the first polymeric material and the second polymeric material, wherein the second polymeric material extends along a surface portion of the article; coupling a metallic material to the surface portion of the article to form a part having a metallic surface finish by exposing the article to the metallic material in a metallizing process, wherein the metallic material is not coupled to the first polymeric material.

A method of manufacturing can comprise: applying an ink to a back side of a film to create an image; placing the film into a mold; forming a face plate shape into an area of the film having at least a portion of the image; forming a registration feature into the film or applying a registration feature onto the film; aligning the image with a protrusion by using the registration feature to position the film in a mold; molding a polymeric material adjacent to the back side of the film to form an indicator panel, wherein the polymeric material covers at least a portion of the image and forms the protrusion on the front side of the film, wherein the protrusion aligns with the image.

An indicator panel can comprise: a film having a front side and a back side; an ink disposed on the back side of the film, wherein the ink forms an image; a face plate shape formed into an area of the film having at least a portion of the image; a first polymeric material disposed adjacent to the back side of the film and covering at least a portion of the image; and a protrusion extending from the front side of the film, wherein the protrusion comprises the polymeric material.

The above described and other features are exemplified by the following figures and detailed description.

### BRIEF DESCRIPTION OF THE DRAWINGS

Having thus described the invention in general terms, reference will now be made to the accompanying drawings, which are exemplary embodiments, not necessarily drawn to scale, are meant to be illustrative and not limiting, and wherein the like elements are numbered alike.

FIG. 1 is an illustration of a front view of an integral indicator panel.

FIG. 2 is an illustration of a cross sectional view of the integral indicator panel of FIG. 1 taken along the A-A plane.

FIG. 3 is an illustration of an integral indicator panel.

FIG. 4 is an illustration of a portion of a formed film having an ink image and holes.

FIG. 5 is an illustration of portion 100 of the formed film of FIG. 4 depicting polymeric material protruding from the front side of the formed film.

FIG. 6 is an illustration of an integral indicator panel.

FIG. 7 is an illustration of portion 100 of the indicator panel of FIG. 6 depicting a protrusion from the front side of an integral indicator panel.

FIG. 8 is an illustration of a front view of an integral indicator panel.

FIG. 9 is an illustration of a cross-sectional view of several examples of face plate shapes.

### DETAILED DESCRIPTION

In vehicle design, a problem to continually be solved can include reducing the cost and/or weight of vehicle components while improving the quality, and/or providing additional stylization and customization opportunity. The present subject matter can provide a solution to this problem, such as by integrally forming a vehicle component which can eliminate separate parts, and seams therebetween, eliminate process operations such as assembly and separate part molding operations, provide a panel having a “Class A” finish, reduce or eliminate the need for separate protective coverings, and allow for customization of finishes, colors, and lighting effects.

Vehicle components having metallic surface finishes can include metal parts and plastic parts joined together. The metal parts can be plated (e.g., chrome plated). The plastic parts can be affixed to the metal parts or vice versa to provide an assembly having metallic surface finishes. A plating process can include surface treatment of metal parts in preparation for plating. Such preparations can include chemical treatments, such as acid washing. Such preparations can include mechanical treatments, such as sanding, buffing, polishing, and the like. These preparations can be costly and can be time consuming. Additionally, a plated metal part can be heavy in comparison to a similar volume plated plastic part.

Components of an indicator panel as used in a dashboard display can include a formed part, a light pipe, and a border. The formed part can include the face of an indicator panel. The formed part can have an ink image printed onto its front side for displaying a value of a variable to a viewer of the indicator panel. The light pipe can be a single molded part and can be positioned behind the film. The light pipe can have protrusions extending through notches and/or holes in the formed part. Light can transmit from a light source on the back side of the indicator panel through the light pipe to the face of the indicator panel to illuminate portions of the panel. A border can surround an indicator panel and can seal a seam between the light pipe and the formed part to reduce the amount of light leaked from the light pipe.

Disclosed herein are molded plastic components capable of having a metallic surface finish along a portion and methods of manufacturing the same. These methods can allow for the manufacture of plastic parts having portions with metallic surface finishes. These methods can include a two shot injection molding process. These methods can include an insert molding process.

These components can be formed from polymeric materials by injection molding, thermoforming, vacuum forming or similar forming processes. These components can include multiple sub-components which can be manufactured in separate processes and assembled together. Manufacturing in this way can require significant tooling to form the sub-components, including multiple molding operations and labor or robotic infrastructure to assemble the parts into a finished component. This can result in increased cost and/or manufacturing time for these components. Additionally, gaps can be formed between the sub-components as a result of an imperfect fit between separately manufactured and assembled parts. These gaps can expose sub-components to weather. These gaps can allow ingress of debris, moisture, UV radiation, and the like to the sub-components. Weather and other elements can affect the aesthetic of the component and can accelerate separation of, or deterioration of, the sub-components. These gaps can allow light to leak from a back lit panel and reduce the aesthetic appeal. A cover can be provided to protect an image printed on the front of an indicator panel from removal, alteration, or damage. A cover can help to seal the indicator panel, but can further increase the cost of the assembly.

Disclosed herein is an indicator panel, such as for use in a vehicle dashboard display, and methods of manufacturing the same. In particular, an indicator panel having integrally formed protruding elements and a method of molding the same is disclosed. By integrally forming an indicator panel, a separate outer cover can be eliminated and the manufacturing process can be streamlined, reducing and/or eliminating manufacturing operations such as molding operations and/or component assembly.

As used herein, the term “face plate” can refer to the ornamental design of the display face of a measurement gauge or other indicator to convey the value of a variable to a viewer. For example, a face plate can include gradation marks and corresponding numbers to represent a range of values of a variable, such as a vehicle speedometer or tachometer.

As used herein, the term “face plate shape” or “shape of a face plate” can refer to the three dimensional form of the face plate, including the perimeter shape (as in the shape of a face plate projected into the x-y plane of the attached figures) and the cross-sectional shape (or profile shape, as in the shape of a cross section of the face plate taken along either the x-z plane or the y-z plane in the attached figures).

An indicator panel can include a film having a front side and a back side, an ink applied to the film, and a polymeric material molded to the film and/or ink. Ink can be applied to the back side of the film to form an image on the film. An area of the film can be formed into the shape of a face plate. An area of the film, not formed into the shape of a face plate, can form an indicator panel frame, or film frame. The polymeric material can be molded adjacent to the back side of the film to form an integral indicator panel. In this way the ink image can be covered (i.e., contained, or sandwiched), at least partially, between the film and the polymeric material. Covering at least a portion of the ink offers protection to the ink from both the front side and back side of the indicator panel, such that the covered ink cannot be removed without destroying the indicator panel.

An indicator panel can have any shape. For example, an indicator panel can be circular, oval, or any simple closed polygonal shape (e.g., cyclic, equiangular, equilateral, tangential, and rectilinear polygons, further including triangular, quadrangular, pentagonal, hexagonal, heptagonal, octagonal, star shaped, and the like) with straight or curved edges. An indicator panel can have one or more face plate shapes formed therein.

A face plate shape can be formed in any shape into the indicator panel and can be positioned anywhere on the indicator panel. For example, a face plate shape can be circular, oval, or any closed polygonal shape (e.g., cyclic, equiangular, equilateral, tangential, and rectilinear polygons, further including triangular, quadrangular, pentagonal, hexagonal, heptagonal, octagonal, star shaped, and the like) with straight or curved edges. Two or more face plate shapes can be spaced apart from one another on an indicator panel. Two or more face plates can abut one another on an indicator panel. Two or more face plates can overlap one another on an indicator panel. A smaller face plate(s) can be positioned within a larger face plate shape on an indicator panel. Two or more face plate shapes can be different from one another, as in having different perimeter and/or cross sectional shapes. Two or more face plate shapes can complement one another on an indicator panel. For example, a first face plate can be circular and can be adjacent, or abutted, along a portion of its perimeter by a second face plate having a crescent shape, e.g., to appear as if the first face plate is in front of the second face plate.

The face plate shape can include a central portion and a peripheral portion. The profile of the face plate, or cross-sectional shape in an x-z plane of a y-z plane in the attached figures, can vary throughout the area of the face plate shape, as measured along the x-axis and y-axis dimensions in the attached figures. The profile of the central portion of the face plate shape can have any shape, e.g., the profile can have a convex, concave, flat, raised, and/or a recessed area. Similarly, the profile of the peripheral portion of the face plate shape can have any shape, e.g., the profile can have a convex, concave, flat, raised, and/or a recessed area. The peripheral portion of a face plate shape can form a border with the remainder of the indicator panel. A transition between areas of an indicator panel can have any shape, e.g., the cross sectional shape of a transition can form a smooth curve, a bevel, a slope, a vertical, and the like. A transition can connect, for example, two different areas within a face plate (within a central portion, within a peripheral portion, between a central and a peripheral portion, between a peripheral portion and a border, and the like), an area of a face plate and an area of an indicator panel frame, and the like.

The film of the indicator panel can form the face of the indicator panel which is viewed by an observer, or viewer, of the panel. The film can have a front side, or front surface, and a back side, or back surface. Each side of the film can have aesthetic and/or functional (e.g., glare reduction) surface finish, such as stippled, smooth, patterned, and the like. Specifically, the front side of the film can have a “Class A surface” finish (at a minimum, such surfaces can be smooth, glossy, and weatherable), while the back side of the film has a textured surface finish (e.g. including stippled, matte, and other finish textures that can scatter light incident on the surface). As used herein, the term “Class A surface” is given the general meaning known in the art and refers to a surface substantially free of visible defects such as hair-lines, pin-holes and the like. The front surface of the film can form at least a portion of the front side of the indicator panel. The film can be transparent, as in allowing for light transmission and image formation through the film. The film can be translucent as in light transmitting. The film can include a base layer free of other layers. Optionally, the film can include a functional layer disposed on a surface of the base layer, or on a surface of an optional functional layer of the film. A functional layer can include an ultraviolet (UV) radiation protecting layer, abrasion resistant layer, electrically conductive layer, anti-frost layer, anti-fog layer, or a combination comprising at least one of the foregoing layers.

The film can have an opening of any shape. For example, an opening can have the shape of a character (number, letter, symbol, logo, or icon), or scale mark (indicia, tick mark, and the like). The opening can extend in the thickness dimension of the film, i.e., perpendicular to the surface, to form a hole through the film. Holes through the film can be used for different functions. A hole can be used to represent a character or scale mark. A hole can be used to allow a movement mechanism to pass through the film from the back side to allow a pointer to be positioned on the front side of the film for displaying the value of a variable to an observer.

Ink can be applied to the film using any desired method. An ink can be applied across the entire area, or across a portion(s), of the film. An ink can include a pigment, an adhesion promoter, a UV reducer, a textural element, a solvent, a carrier material, or a combination comprising at least one of the foregoing. The physical, optical, and/or chemical properties, type, and/or composition of the ink can vary throughout the area that the ink is applied to the film. The ink can have any color, including white, black and gray scale colors. The ink can be light transmissive. The ink can be opaque. The ink can be non-luminescent. The ink can be luminescent, as in electroluminescent, photoluminescent, and the like, such as fluorescent. The ink can include a reflective component. A reflective component can be applied to the film or to the ink. The reflective component can form a reflective layer. The reflective layer can reflect 5% to 100% of the incident visible light (e.g., electromagnetic radiation having a frequency of 430 THz (Terahertz) to 790 THz), for example, 5% to 50%, or 5% to 25%. The reflective layer can have a light transmittance of visible light of 0% to 95% as determined by ASTM D1003, for example, 50% to 95%, or 75% to 95%. The ink can include a light diffusing component, such as a metal oxide (e.g., TiO₂, BaSO₄, MgO, SiO₂, and Al₂O₃). The ink can include a clear matte layer. Ink can be applied on the film in the shape of an image such as a character (number, letter, symbol, logo, or icon), scale mark (indicia, tick mark, and the like), and/or other graphic. For example, opaque ink can surround the image of a character printed with light transmissive ink to provide contrast, such that light transmitted from the back side of the film can pass through the light transmissive ink and illuminate the image but not the surrounding material. In this way, the contrast can provide a sharp clear image to the viewer of the front side of the indicator panel.

Images, such as scale marks and characters, can be used in conjunction with a pointer to convey the value of a variable to a viewer of an indicator panel. For example, scale marks can be positioned on an area of a face plate shape to represent an indicator, such as a dial indicator. More than one set of scale marks can be provided on a single face plate shape. For example, a face plate can have a first set of scale marks representing a first variable and second set of scale marks representing a second variable. In this way, a single movement mechanism having as single pointer, or needle, can be used to point to two different values of a variable simultaneously (e.g., speed in kilometers per hour and in miles per hour, or more generally, variables that are related to one another through a conversion factor). Similarly, multiple pointers, or needles, can be used to point to values of different variables on a single scale (e.g., clock having an hour, a minute, and a second hand).

Tie layers, bonding layers, other adhesive layers, barrier layers, and/or other interlayers can be disposed between the ink and the film, between the ink and the polymeric material, and/or between functional and base layers of the film. The use of such layers can provide additional adhesion between the layers of the integral indicator panel. These layers can help to minimize separation of layers of the integral indicator panel, and/or can help resist ink washout (ink spreading) when the polymeric material is formed onto the film, as in during a molding operation.

Polymeric material can be applied to a surface of the film and/or ink. The polymeric material can be applied to the back surface and/or front surface of the film and/or ink. The polymeric material can extend perpendicularly from the surface to which it is applied to form a volume of polymeric material.

The polymeric material can extend into a hole in the film from a side of the film such that the polymeric material is flush with the film surface on the other side of the film. The polymeric material can extend through a hole in the film and form a protrusion of polymeric material on the other side of the film. Polymeric material can extend into and/or through a hole in the film filling the entire hole or filling a portion of the hole, e.g., polymeric material can extend into a hole along an edge(s) of the hole to border the inside perimeter of a hole. The polymeric material can chemically bond to the film. The polymeric material can be chemically bonded to the film by an adhesive layer disposed between the film and the polymeric material (e.g., applied onto an ink layer, incorporated into an ink composition, and the like). The polymeric material can be held in position relative to the film mechanically, such as forming lips that can extend along both sides of the film to secure the polymeric material to the film.

The physical, optical, and/or chemical properties, types, and/or composition of the polymeric material can vary throughout the area/volume that the polymeric material is applied. The polymeric material can have any color, including white, black, and gray scale colors. The polymeric material can be transparent, as in allowing for light transmission and image formation through the material. The polymeric material can be translucent. The polymeric material can be opaque. The polymeric material can be can be luminescent, as in electroluminescent, photoluminescent, and the like, such as fluorescent.

Polymeric material can be used to direct light from a light source to a light transmissive area of the film having no ink, or where a light transmissive ink is applied. In this way, a scale mark and/or a character can be illuminated. Alternatively, or in addition, the area surrounding a scale mark and/or a character can be illuminated (e.g., a “dead front” graphic which can be white during the day and illuminated at night). To achieve various illumination schemes, the polymeric material can be used as a light pipe to transmit light to an area of the film where illumination is desired. To reduce the occurrence of light leaking out of a section of polymeric material as it is transmitted (or transmitting from one section to another section), several strategies can be employed. For example, one strategy can be to form the polymeric material in discontinuous or independent sections. Another strategy can be to surround, or partially surround, light transmissive polymeric material with opaque and/or light reflective polymeric material. Another strategy is to form ribs of opaque polymeric material between sections of light transmissive polymeric material to quarantine light into sections. One of, or a combination of, these strategies can be used to illuminate different areas of the indicator panel with different lights, different colored lights, at different times, and/or under different conditions (e.g., operating conditions).

A protrusion can extend from the front surface of the film. A protrusion can be located anywhere along the front surface of the indicator panel, such as within a central or peripheral portion of a face plate, in the frame, and the like. A protrusion from a side of the film can be formed by pushing the other side of the film (with or without ink applied to the film) with polymeric material. A protrusion from a side of the film can be formed by pushing the other side of the film (with or without ink applied to the film) with a gas (e.g. air). The film (and optional ink) can remain intact, e.g., not broken, and the protruded material can include film, polymeric material, or ink, or a combination of at least one of the foregoing. A protrusion can be coincident with an ink image applied to the film, such as a character or scale mark.

A protrusion can have any shape. The cross-section of a protrusion can have any shape, where the cross-section can be taken in a plane parallel to a surface from which the protrusion extends or tangent to a surface from which the protrusion extends in a case where the protrusion extends from a contoured section of the film. The cross-section of a protrusion can have the shape of a character (number, letter, symbol, logo, or icon), or scale mark (as in an indicia, tick mark, and the like). The cross-sectional shape of a protrusion of polymeric material extended through a hole in the film can have the same shape as the hole. For example, a protrusion can form a tick mark and can have a “jewel” shape, i.e., the shape of a truncated pyramid elongated along one dimension.

The indicator panel can include an opening of any shape. The opening can extend through the thickness dimension of the panel (smallest dimension of panel) to form a hole through the panel. A movement mechanism can extend through a hole in the panel and connect to a pointer, or needle. A pointer can be moved by a movement mechanism to point to a character or scale mark image applied to the film, such as to convey the value of a variable to a viewer. A hole through an indicator panel can form a window into which a display element can be positioned to provide additional information to a viewer, e.g., to display the values of other variables, including counters, discrete values, indicator lights, symbols, static or dynamic messages, and the like. A display element can include a liquid crystal display (LCD), a light emitting diode (LED) display, any device capable of displaying visual information, and the like. A hole through the indicator panel can allow for a fastener to extend through the hole and secure the panel to a support, such as a dashboard or dashboard assembly.

Optionally, a moving mechanism having an attached pointer (i.e., needle) or a display having a pointer image can be positioned behind a portion of an indicator panel (i.e., adjacent the back side of the film). The portion of the indicator panel can be transparent, and optionally free of ink, such that the pointer, or displayed pointer image, can be seen by a viewer from the front side of the indicator panel. In this case, the pointer image can be displayed on a separate display element, projected onto the ink and/or film, or otherwise made visible to the viewer of the front side of the indicator panel. Disposed in such a way, sections of an indicator panel can be seamless and spill-proof, reducing or eliminating the need for a separate cover to protect from ingress of dust, bugs, debris, and/or spilled liquids.

The indicator panel can be formed using an In-Mold Decoration (IMD), or similar process. Such process can include applying ink onto an area of a film, forming a shape into the film, and molding polymeric material to the film and/or ink, such as in an injection molding process.

Applying an ink to a film can include applying ink onto an area of the film. Applying an ink to a film can include applying ink in the form of an image (e.g., character, scale mark, graphic, and the like) onto an area of the film, such as screen printing, pad printing, membrane image transfer printing, transfer printing, ink jet printing, robotic dispensing, spraying, offset printing, sublimation printing, digital printing, and the like, or any other technique known to those skilled in the art of applying an image to a film. Ink can be applied to the front side and/or back side of the film. Ink can be applied to the film when the film is flat, i.e., where the film is substantially even across the surface to which an ink is to be applied, or before a shape is formed into the film. “Substantially” as used herein can refer to accommodating for surface variations due to surface treatments (e.g., stippling), variation in physical position and/or structure at the molecular level, and/or variations due to machine and/or quality control tolerances during manufacturing. Ink can be applied to a formed film, such as after a shape is formed into the film in a forming process.

Forming a shape into the film can include forming a face plate shape, indentation, protrusion, recess, or the like into at least a portion of the film, such as thermoforming or similar processes. Forming a shape into the film can include forming a notch, a hole, and the like into the film, such as in a trimming, punching, cutting, or similar process. Forming a shape into the film can include forming a protrusion that extends from a surface of the film. A forming process can be carried out before or after ink is applied to the film.

A film can include a registration feature. A registration feature can include any physical and/or optical feature of the film and/or ink to ensure alignment of the film with a processing tool (e.g., die). For example, a physical registration feature can include a hole, notch, indentation, recess, protrusion, and the like, or combination of at least one of the foregoing, formed in the film and/or ink. An optical registration feature can include any feature that can be optically detected and used as a feedback mechanism to adjust the position the film (with ink) in a processing tool, e.g., a light reflecting, absorbing, or transmitting spot. In this way a registration feature can be used to correctly, positively, position the film (with or without ink) in a processing tool, such as a thermoforming die, trim die, mold die, clamp frame, or the like. A registration feature can be located at an area of the film that will be held in a clamp frame in a processing apparatus, such as a thermoforming apparatus, trimming apparatus, molding apparatus, and the like. In this way the position, shape, and integrity of a registration feature can remain unaltered, or minimally altered, by the process (e.g., unaffected or minimally affected by a thermal and/or mechanical process) being performed on the film (with or without ink). In this way, a registration feature can be used throughout the manufacturing process without compromising its functionality. In an embodiment, a pin in a processing die can extend into or through a registration hole to ensure the correct alignment between a printed image and a die cavity. In an embodiment, a registration feature can be formed into a film before, or at the same time, that a shape is formed into the film.

A registration feature as described herein can be used to position a film such that all edges of an image on the film can be within ±0.5 millimeters (mm), for example, ±0.3 mm, or ±0.2 mm of all the edges of a feature (cavity, protrusion, edge, and the like) in a processing tool, such as a feature in a thermoforming die, trim die, mold die, clamp frame, or the like. The notation “±0.5 mm” means that the indicated measurement may be from an amount that is minus±0.5 mm to an amount that is plus±0.5 mm of the stated value.

An indicator panel structure described herein can be made using various methods to mold polymeric material to the film and/or ink. These methods can include single shot molding using a single gate, single shot molding using multiple gates, multi-shot molding using a single gate, and/or multi-shot molding using multiple gates. Molding polymeric material to the film and/or ink can include molding using a single shot to form a continuous section of polymeric material adjacent to the back side of the film. Molding polymeric material to the film and/or ink can include molding using a multi-shot molding process (e.g., molding a light transmissive polymeric material followed by an opaque polymeric material or vice versa). Molding polymeric material to the film and/or ink can include molding using a multi gate molding process (e.g., injecting through different gates to form physically separated sections of polymeric material).

Once a polymeric material is formed into an article, a metallic material can be adhered to a surface of the article to provide a metallic surface finish. This can be done by exposing the article to a metallization process which can include transferring a metallic material to the surface such as in a coating, deposition, plating, or similar process. A metallic material can include a pure metal (e.g., gold, silver, chrome, nickel, rhodium, copper, zinc, tin, and the like), a metal oxide, or a metal alloy. Portions of the article can include a polymeric material that is resistant to metallic material during a metallization process. Portions of the article can include a polymeric material that accepts metallic material in a metallization process. A polymeric material that is resistant to metallization can exhibit an adhesion value of less than 0B as determined by ASTM D3359. A polymeric material that accepts metallization can exhibit an adhesion value of greater than or equal to 0B as determined by ASTM D3359, for example, 0B to 5B, or, 3B to 5B, or, 5B. When exposed to a metallization process, a metal can adhere to less than 35% of the surface of a polymeric material that is resistant to metallization, for example, 0% to 20%, or, 0 to 0.5%. When exposed to a metallization process, a metal can adhere to greater than 65% of the surface of a polymeric material that accepts metallization, for example, 65% to 100%, or, 90% to 100%, 95% to 100%, or 99.9%.

The article can include a substrate free of another layer or coating. Optionally, the article can include a functional layer or coating disposed on a surface of the substrate, or on a surface of an optional functional layer or coating of the article. A functional layer or coating can include a bonding, an adhesive layer, an ultraviolet (UV) radiation protecting layer, abrasion resistant layer, electrically conductive layer, anti-frost layer, anti-fog layer, or a combination comprising at least one of the foregoing layers. In an embodiment, the article can include a bonding layer to aid in bonding a metallic material to the surface of the article and an abrasion layer disposed over the metallic material.

Molding can include molding a portion of a part with a polymeric material that resists metallization such as LEXAN™ and/or XYLEX™, both of which are commercially available from SABIC's Innovative Plastics business (e.g., LEXAN™ SLX1432, LEXAN™ SLX1432T, and LEXAN™ SLX2271T). Molding can include molding a portion of a part with a polymeric material that can accept metallization such as CYCOLOY™, commercially available from SABIC's Innovative Plastics business (e.g., CYCOLOY™ MC1300). In an embodiment, a first portion of a part can be molded with a polymeric material that resists metallization and a second portion of a part can be molded with a polymeric material that accepts metallization.

Molding polymeric material to the film can include molding a rib structure of a polymeric material to a side of the film. Molding polymeric material to the film can include molding a discontinuous section of polymeric material to the film. Molding polymeric material to the film can include molding optically separated sections of translucent polymeric material to a side of the film (where sections can be independently lit, or where a light can illuminate through one section without illuminating through another section). Molding polymeric material to the film can include molding a continuous section of polymeric material to the film. Molding polymeric material to the film can include molding a protrusion that extends from a side of the film. Molding a protrusion can include molding a polymeric material that extends through a hole in the film from a side of the film to form a protrusion on the other side of the film. Molding a protrusion can include pushing polymeric material into a side of the film to force the film to protrude on the other side of the film, where the film and optional ink applied to the film remains intact along the protrusion.

In a molding process, a die can have a cavity corresponding to a protrusion to be formed from a surface of the film. The cavity in the die can have any shape. The cross-sectional shape of a cavity in a die can have any shape. The cross-sectional shape of a cavity in a die can vary along the depth of the cavity (measured in a direction perpendicular to the surface at the face of the die). The cross-sectional shape of the cavity in the die can be the same shape, or match, the shape of an ink image applied to the film. The cross-sectional shape of the cavity in the die can be the same shape, or match, the shape of a hole through the film. A protrusion, extending from a film surface, can be formed in a molding process by the pressure of the polymeric material pushing the film into a cavity in a die. A protrusion, extending from a film surface, can be formed in a molding process by injecting polymeric material through the film and into a cavity in a die.

A die can have a sealing feature for sealing the film to a die face such that the polymeric material cannot extend past a sealed edge of the film (e.g., the edge of a hole through the film). A sealing feature in a die can include an extension, insert, and/or a suction means, such that a surface of the film is firmly pressed, or pulled, against a die face. A extension or insert can include a pin, tab, ring, or other protrusion feature, and can optionally be spring loaded to accommodate variation in film thicknesses such that a protrusion formed on a film surface can have a consistent size (e.g., extend the same distance from a film surface) even if the film thickness varies within a film or between films. A sealing feature can “shut-off” the film against a die face to ensure that no polymeric material leaks onto a surface of the film abutting the die face. For example, an injection plate, of an injection molding die set can include spring loaded pins that push a film against the opposing plate, or ejector plate, along the edge of a hole through the film around a cavity in the ejector plate when the die set is brought together. In this way, polymeric material can be confined to the cavity in the ejector plate and can be prevented from leaking between the film and the surface of the ejector plate.

The film can be made of metal or polymeric materials including thermoplastic materials as well as combinations of thermoplastic materials with elastomeric materials and/or thermoset materials. The film can be made of a polymeric material that accepts metallization. The film can be made of a polymeric material that resists metallization. Possible thermoplastic materials include polybutylene terephthalate (PBT); acrylonitrile-butadiene-styrene (ABS); polycarbonate (LEXAN™, LEXAN™ SLX and LEXAN™ EXL resins, commercially available from SABIC's Innovative Plastic business); polycarbonate/PBT blends; polycarbonate/ABS blends; copolycarbonate-polyesters; acrylic-styrene-acrylonitrile (ASA); acrylonitrile-(ethylene-polypropylene diamine modified)-styrene (AES); phenylene ether resins; blends of polyphenylene ether/polyamide (NORYL™ GTX resins, commercially available from SABIC's Innovative Plastic business); blends of polycarbonate/polyethylene terephthalate (PET)/PBT; polybutylene terephthalate and impact modifier (XENOY™ resins, commercially available from SABIC's Innovative Plastic business); polyamides; phenylene sulfide resins; polyvinyl chloride PVC; high impact polystyrene (HIPS); low/high density polyethylene (L/HDPE); polypropylene (PP); expanded polypropylene (EPP); polyethylene and fiber composites; polypropylene and fiber composites; long fiber reinforced thermoplastics (VERTON™ resins, commercially available from SABIC's Innovative Plastic business) and thermoplastic olefins (TPO), as well as combinations comprising at least one of the foregoing.

The polymeric material can include any of the polymeric materials listed for the film. In an embodiment, the film and the polymeric material can be made from the same polymeric material.

The film thickness (shortest dimension of the film) can be 0.1 mm to 10 mm thick. The film thickness can be 0.1 mm to 1 mm. The film thickness can be from 0.1 mm to 0.5 mm. The film can be 0.375 mm thick.

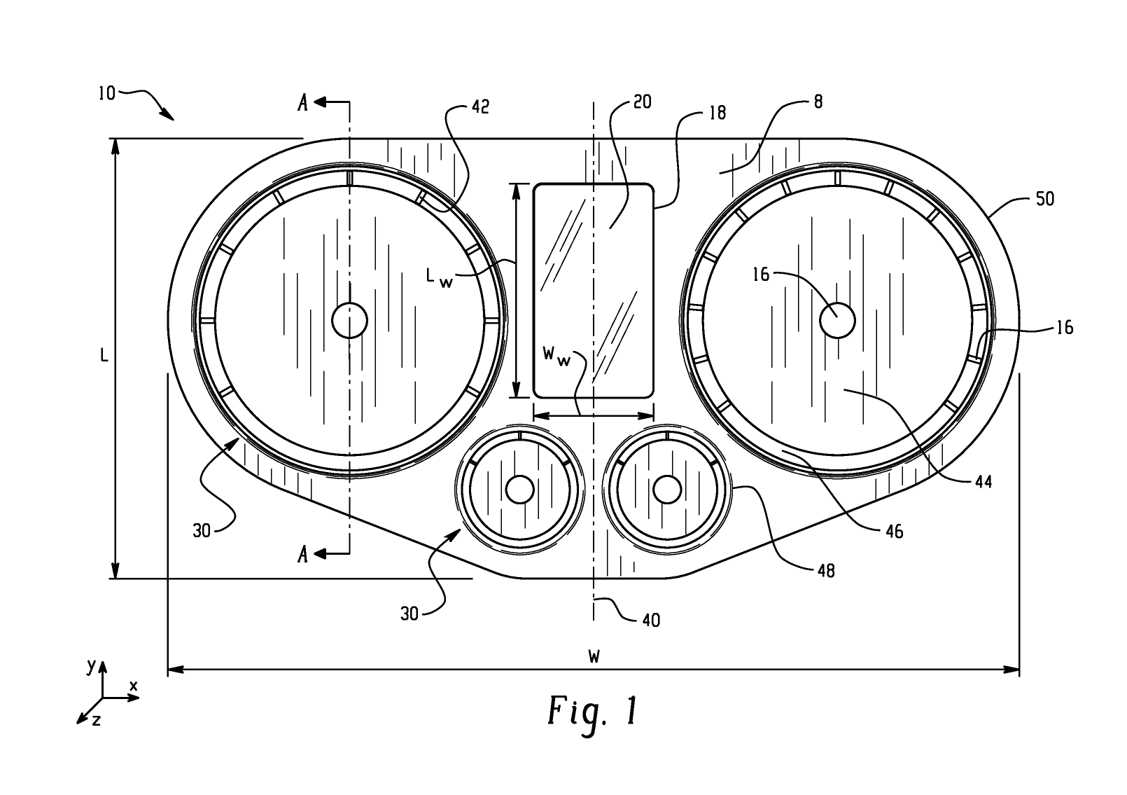

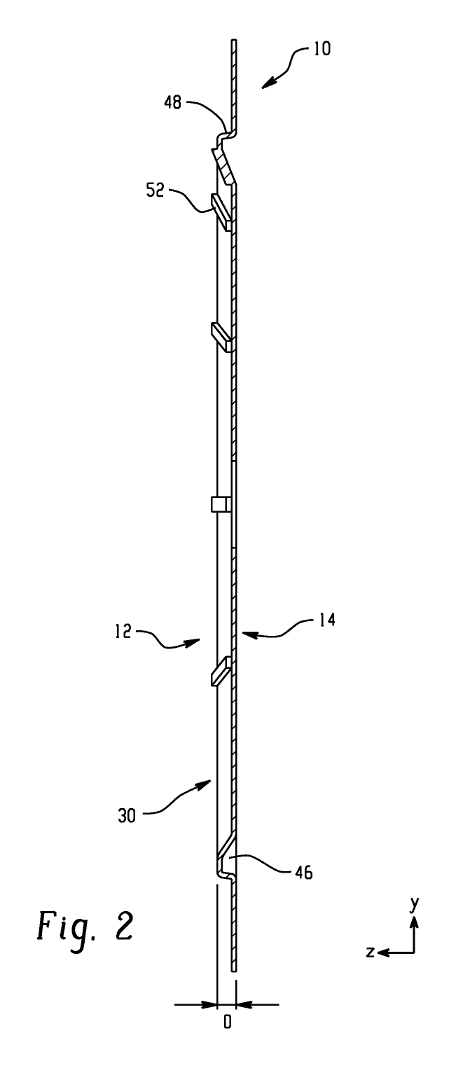

FIG. 1 shows an illustration of an indicator panel 10 having a frame 8, window 20 and four round face plates 30 formed into the panel. As illustrated, the face plates 30 can have varying sizes, for example, two of the face plates 30 can be larger than the other two face plates 30. The four face plates 30 can be positioned symmetrically about the centerline 40 which bisects the width W, measured along the x-axis dimension, of the indicator panel 10. The face plates 30 can each have a flat central portion 44 and a sloped peripheral portion 46 which can form a vertical border 48 at the edge of the face plate 30 abutting the frame 8 of the indicator panel 10. Extending from a front side 12 of the indicator panel 10 can be protrusions 52 (see FIG. 2). The protrusions 52 can be formed of polymeric material that extends through holes 16 in the film of the indicator panel 10. Protrusions 52 can form scale marks 42. The scale marks 42 can be equally spaced circumferentially around the sloped area of peripheral portion 46 of the face plates 30. Holes 16 can be formed through the panel at the center of each face plate 30. The holes 16 can allow for a movement mechanism to extend through the panel and attach to a pointer, or needle, which can extend radially and can be moved by the movement mechanism to indicate a change in the indicated value of a variable. The indicator panel 10 can have a rectangular opening 18, having an elongated length L_{w} measured in the y-axis dimension and a width W_{w} measured in the x-axis dimension. The opening 18 can extend through a depth, D, of the indicator panel 10, as measured in the z-axis dimension, to form a window 20 through the indicator panel 10. The opening 18, forming window 20, can be centered in the indicator panel 10 and can allow for a display element (e.g., LCD, LED, other display element, and the like) to be positioned in the window 20. A display element can provide additional information to the viewer of the indicator panel 10. A separate display element can be positioned such that it is flush with the front side 12 of the indicator panel 10. Such additional information can include symbols, characters, numbers, and the like, for a vehicle application, for example, the additional information can include mileage, “tell-tale” symbols, such as a “check engine” symbol, and the like.

FIG. 2 shows an illustration of a cross sectional view of the indicator panel 10 of FIG. 1 taken along the A-A cross section. As illustrated, face plate 30 can be formed into the indicator panel 10 such that the peripheral portion 46 protrudes from the front side 12 of the indicator panel 10. Protrusions 52 can extend from the peripheral portions 46, and from the front side 12 of the indicator panel, to form the depth, D, of the indicator panel 10, which can be larger than the thickness of the film 24 of the indicator panel 10. A back side 14 of the indicator panel 10 can be flat.

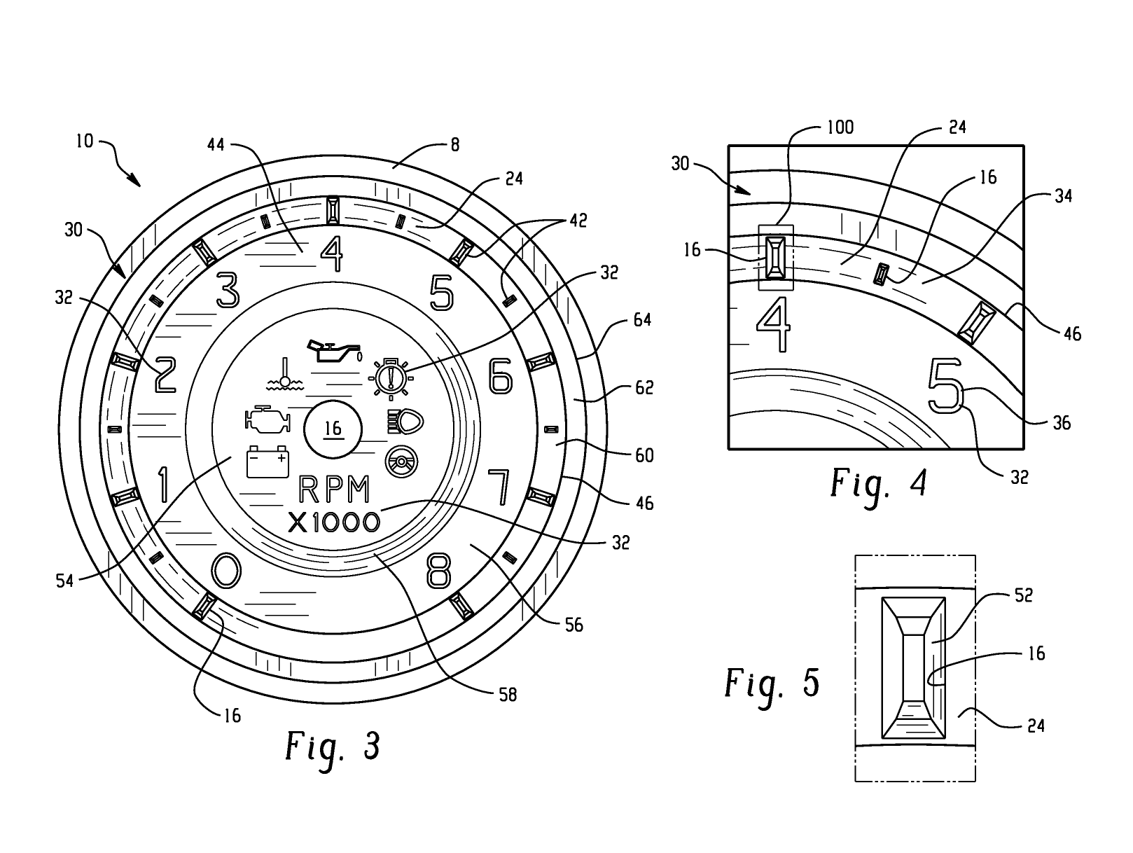

FIG. 3 shows an example of an indicator panel 10 having a single round face plate 30 surrounded by a frame 8. The central portion 44 of the face plate has a raised area 54 surrounded by a flat area 56. A transition 58 having a smooth curve can connect the raised area 54 to the flat area 56. The peripheral portion 46 of the face plate 30 can have a sloped area 60 which can be surrounded by a flat area 62. A vertical transition 64 can connect the perimeter edge of the face plate to the frame 8. Differently colored inks can be applied to the back side 14 (indicated in FIG. 2) of the film. Inks can be applied to form images of characters 32. The characters 32 can include numbers, letters, and symbols, and/or icons, which can be surrounded by black non-translucent ink. A hole 16 can be centered in the face plate. The hole 16 can allow for a movement mechanism, including a pointer, to extend through the hole 16 and point to a scale mark 42 to indicate the value of a variable to a viewer. Protrusions of polymeric material can extend through holes 16 to form scale marks 42. Scale marks 42 can include major and minor scale marks. Holes 16 can be formed through the film in the sloped area 60. The protrusions 52 (see FIG. 2) can be formed from translucent clear (non-pigmented) polymeric material molded through the film 24 from the back side 14 (see FIG. 2) of the film 24.

FIG. 4 is an example face plate 30 formed into a film 24 and having holes 16 formed through the peripheral portion 46 of the face plate 30. Ink can be applied to the film 24 to create an image. The image can be in the form of a character 32. As illustrated, black ink 34 can surround white ink 36 to create the image of a character 32. The film 24 can have a stippled appearance. The area 100 of film 24, after it has been back molded with translucent clear polymeric material, is enlarged in FIG. 5.

FIG. 5 is an example of the film 24 of the area 100 of FIG. 4 after it has been back molded with translucent clear polymeric material to form an integral indicator panel. A jewel shaped protrusion 52 of polymeric material can extend through the hole 16 to represent a scale mark 42 on the front side 12 of the indicator panel 10 (corresponding to the front side of film 24).

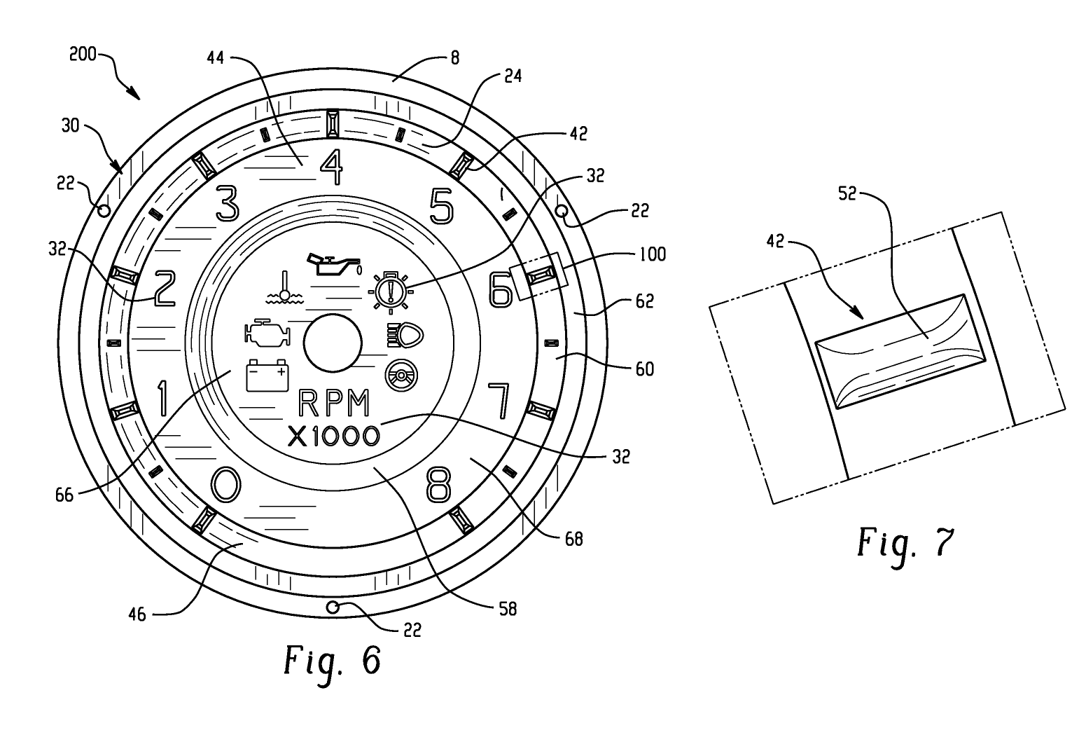

FIG. 6 shows an example of an indicator panel 200 having a single round face plate 30 surrounded by a frame 8. The central portion of the face plate 30 can have a recessed area 66 surrounded by a gradually sloped area 68. The recessed area 66 can be connected to the gradually sloped area 68 by a transition 58 having a smooth curve. A peripheral portion 46 having a sloped area 60 and a flat area 62 can surround the central portion 44 of the face plate 30. The cross-section of the indicator panel 200 is similar to that of FIG. 2, but protrusions 52 in indicator panel 200 can have a more rounded, less square geometry. Inks of different colors, applied to the back side 14 (see FIG. 2) of the film 24, can form characters 32. The characters can be positioned in the gradually sloped area 68 and in the recessed area 66 of the central portion 44 of the face plate 30. Scale marks 42 can be positioned in the sloped area 60 of the peripheral portion 46 of the face plate 30. Registration features 22, in the form of holes through the frame 8, can be equally spaced circumferentially around the round face plate 30. These features can be used, for example, to ensure that a printed and formed film is positioned in an injection molding operation such that the scale marks 42 are aligned with cavities in a mold die adjacent to the front side 12 (see FIG. 2) of the film 24. In this way, the alignment between a printed image (e.g., characters 32, scale marks 42 and the like) and a die cavity can be controlled. Thus, consistent quality (e.g., dimensional integrity) of the indicator panel 200 can be ensured, such that a formed protrusion 52 (see FIG. 5) can be coincident with a printed image.

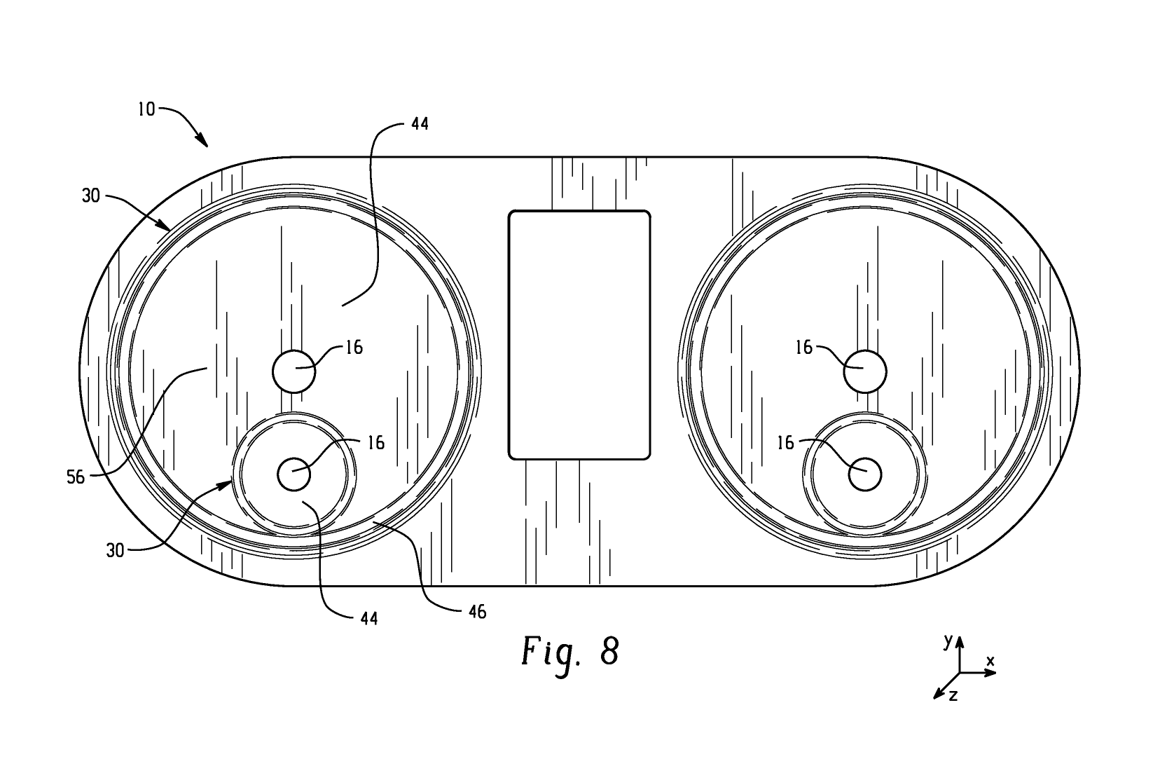

The peripheral portion 46 of the face plate 30 of FIG. 6 can have a sloped area 60 with scale marks 42. The scale marks 42 can be applied with two differently colored inks. For example, a first color ink can be applied to the film 24 corresponding to scale marks 42 adjacent to characters from “0” to “6”, the minor scale marks between consecutive numbers can be the same color. A second color ink can be applied to the film corresponding to the minor scale mark 42 located between the character “6” and “7”. The second color ink can also be applied to the film corresponding to scale marks 42 adjacent to characters “7” to “8”, the minor scale marks between these numbers can be the same color. In this way, a translucent polymeric material can be disposed continuously across the back side 14 (see FIG. 2) of the film 24 and the differently colored ink can provide for characters 32 and/or scale marks 42 to be illuminated in different colors from a light source having a single color. The scale marks 42 can be formed into protrusions 52 extending from the front side 12 (see FIG. 2) of the film 24 of the indicator panel 200. In this case, the protrusions 52 (see FIG. 5) can be formed by pushing polymeric material from the back side 14 (see FIG. 2) of the film 24 and forcing the film 24, ink, and polymeric material into a corresponding die cavity. The area 100 of indicator panel 200 is enlarged in FIG. 7.

FIG. 7 is an example of the indicator panel 10 of the area 100 of FIG. 6. Scale mark 42 can be coincident with protrusion 52 from the front side 12 of the film 24 of the indicator panel 10. The protrusion 52 can have a smooth, bulged, shape created by polymeric material pushed into the back side 14 of the film 24 at the scale mark 42, opposite a corresponding die cavity, during an injection molding process.

FIG. 8 is an illustration of an embodiment of an indicator panel 10 having four round face plates 30. In this embodiment two smaller face plates 30 can be formed into two larger face plates 30, e.g., in a superimposed fashion. Each of the face plates 30 can have a centrally located hole 16 which can allow for a movement mechanism to extend through the indicator panel 10. To allow this to happen, the two smaller face plates 30 can be recessed into a flat area 56 of the central portion 44 of the larger face plates 30, such that the borders 48 of the smaller face plates 30 run along both the central portion 44 and the peripheral portion 46 of the larger face plates 30.

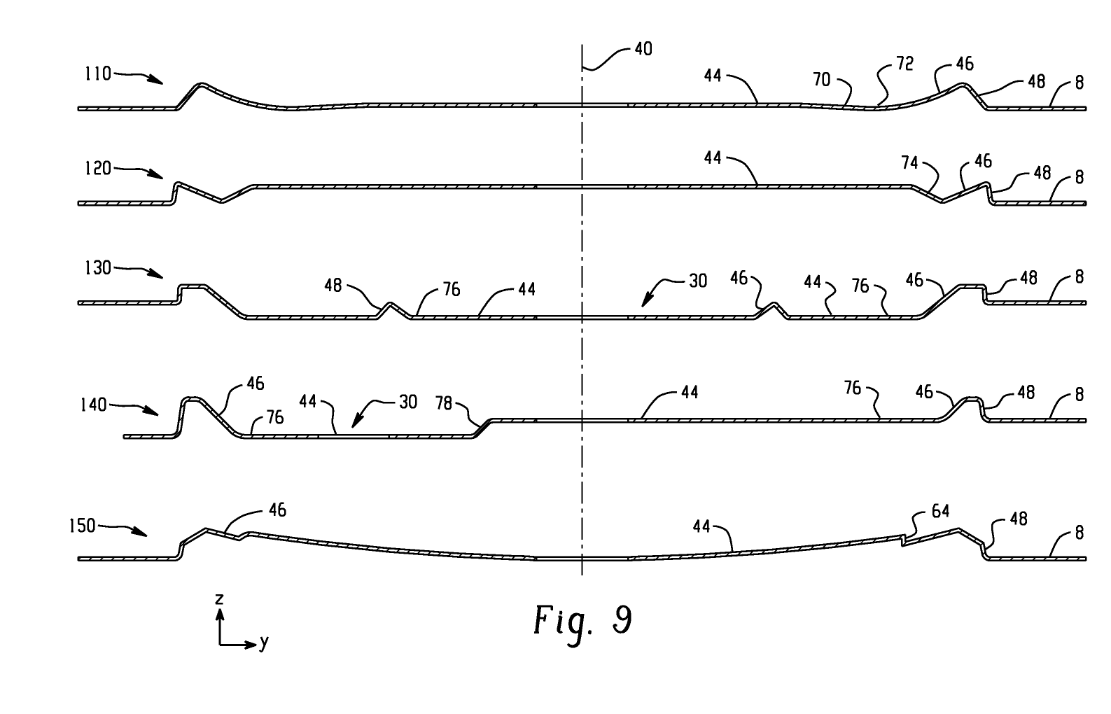

FIG. 9 is an illustration of various cross-sectional shapes of films 24 having one or more face plate shapes formed therein. Each formed film 110, 120, 130, 140, and 150 can have a frame 8, a central portion 44, a peripheral portion 46, a centerline 40, and a border 48. Formed film 110 can have a flat central portion 44, a curved transition 70, having a slight recess 72, to a raised and curved peripheral portion 46, and a sloped border 48. Formed film 120 can have a raised flat central portion 44, a sloped transition 74 to a raised and sloped peripheral portion 46, and a sharply sloped, nearly vertical (i.e., straight along the z-axis dimension), border 48. Formed film 130 can have a recessed flat central portion 44, a flat transition 76 to a raised and sloped peripheral portion 46, and a sharply sloped, nearly vertical, border 48. Formed film 130 can have a second smaller face plate 30, having a flat central portion 44, a flat transition 76, a sloped peripheral portion 46, and sloped border 48, formed therein and symmetric about the center line 40. Formed film 140 can have a flat central portion 44, a flat transition 76 to a raised and sloped peripheral portion 46, and a sharply sloped, nearly vertical, border 48. Formed film 140 can have a second smaller face plate 30 recessed into a larger face plate. The second smaller face plate 30 can have a flat central portion 44, a flat transition 76, and a sloped peripheral portion 46. The sloped peripheral portion 46 can have a borderless transition 78 into the larger face plate (i.e., a connection without a separate border). The second smaller face plate 30 of formed film 140 can be asymmetric about the centerline 40, i.e., it can be formed on one side of the center line 40. Formed film 150 can have a raised concave central portion 44, a vertical transition 64 to a raised and sloped peripheral portion 46, and a sharply sloped, nearly vertical, border 48.

An indicator panel as described herein can be used to display any continuous variable, such as distance, speed, temperature, pressure, time, efficiency, and the like. An indicator panel as described herein can be used to display any discrete variable, such as an on/off condition, when a threshold condition(s) is reached, an operating mode, and the like. An indicator panel configured for displaying a continuous variable can include scale marks. Scale marks can be equally spaced or the scale marks can be unevenly spaced. Unequally spaced scale marks can be used to accommodate a gauge having a non-linear response, e.g., a gauge that moves rapidly between some values, but slowly between other values. Scale marks can be positioned anywhere on the indicator panel, for example scale marks can be positioned on a portion of the perimeter of the shape of the face plate.

An indicator panel as described herein can inform an observer, or viewer, of a value of a variable and can be used in many different industries including automotive, aviation, construction, chemical manufacturing, home electronics, marine, medical, military, petrochemical refining, power generation, process control of any process, or any industry that requires monitoring of a variable.

In an application an indicator panel can be used to display a value of a variable to an operator and/or passenger of a vehicle (e.g., aviation vehicle, cargo vehicle, construction vehicle, farm vehicle, marine vehicle, military vehicle, passenger vehicle, rail vehicle, and the like). In this case, an indicator panel can be positioned in a vehicle dashboard or dashboard assembly. An indicator panel for use in such an application can have a face plate shape for a speedometer, tachometer, coolant pressure indicator, coolant temperature indicator, lubricant pressure indicator, lubricant temperature indicator, reactant pressure indicator, fuel gauge (including fuel economy, range, and fuel level), other temperature and pressure indicators, clock, and the like formed into the indicator panel. An ink image (e.g., of a scale mark and/or a character) applied to the film of the indicator panel can be illuminated by a light source located behind the indicator panel, the side opposite from a viewer of the panel. In this way the panel can provide the viewer with information during day and night.

### Embodiment 1

A method of manufacturing comprising: introducing a first polymeric material to a mold, wherein the first polymeric material resists metallization; introducing a second polymeric material to the mold, wherein the second polymeric material accepts metallization; molding an article from the first polymeric material and the second polymeric material, wherein the second polymeric material extends along a surface portion of the article; coupling a metallic material to the surface portion of the article to form a part having a metallic surface finish by exposing the article to the metallic material in a metallizing process, wherein the metallic material is not coupled to the first polymeric material.

### Embodiment 2

A vehicle component formed by the method of Embodiment 1.

### Embodiment 3

The vehicle component of Embodiment 2, wherein the vehicle component is chosen from a grille, a door handle, an interior trim component, an exterior trim component, a component of an indicator panel, a component of a dashboard display, a component of a gear shifter, a component of a console, a glove compartment handle, a vehicle logo, a vehicle badge, a vehicle emblem, a fascia, a hubcap, an antenna cover, a light surround, a light reflector, or a combination comprising at least one of the foregoing.

### Embodiment 4

A method of manufacturing comprising: applying an ink to a back side of a film to create an image; placing the film into a mold; forming a face plate shape into an area of the film having at least a portion of the image; forming a registration feature into the film or applying a registration feature onto the film; aligning the image with a protrusion by using the registration feature to position the film in a mold; molding a polymeric material adjacent to the back side of the film to form an indicator panel, wherein the polymeric material covers at least a portion of the image and forms the protrusion on the front side of the film, wherein the protrusion aligns with the image.

### Embodiment 5

The method of Embodiment 4, wherein molding comprises pushing a portion of the film from the back side of the film with the polymeric material to form the protrusion.

### Embodiment 6

The method of any of Embodiments 4-5, comprising forming a hole through the film.

### Embodiment 7

The method of any of Embodiments 4-6, wherein forming the registration feature comprises indenting the film, wherein the registration feature can be used to position the film in a processing tool.

### Embodiment 8

The method of any of Embodiments 4-7, wherein applying the ink comprises screen printing, pad printing, membrane image transfer printing, transfer printing, ink jet printing, robotic dispensing, spraying, offset printing, sublimation printing, digital printing, or a combination of at least one of the foregoing.

### Embodiment 9

The method of any of Embodiments 4-8, wherein applying the ink comprises applying the ink to a side of the film while the film is flat.

### Embodiment 10

The method of any of Embodiments 4-9, wherein applying the ink comprises applying the ink to the front side of the film.

### Embodiment 11

The method of any of Embodiments 4-10, wherein forming a face plate shape further comprises forming two or more face plate shapes.

### Embodiment 12

The method of any of Embodiments 4-11, comprising exposing the indicator panel to a metallic material in a metallization process to couple the metallic material to a portion of a surface of the indicator panel.

### Embodiment 13

An indicator panel comprising: a film having a front side and a back side; an ink disposed on the back side of the film, wherein the ink forms an image; a face plate shape formed into an area of the film having at least a portion of the image; a first polymeric material disposed adjacent to the back side of the film and covering at least a portion of the image; and a protrusion extending from the front side of the film, wherein the protrusion comprises the polymeric material.

### Embodiment 14

The indicator panel of Embodiment 13, wherein the first polymeric material is disposed only on the back side of the film.

### Embodiment 15

The indicator panel of any of Embodiments 13-14, comprising a hole through the film, and wherein the protrusion extends through the hole in the film, and wherein the protrusion consists of the first polymeric material.

### Embodiment 16

The method of Embodiment 15, wherein the hole has the shape of a scale mark and/or a character.

### Embodiment 17

The indicator panel of any of Embodiments 13-16, further comprising a hole through the indicator panel and a movement mechanism extending through the hole in the indicator panel, wherein a pointer is in mechanical communication with the movement mechanism such that the pointer can be moved adjacent to the front side of the film.

### Embodiment 18

The indicator panel of any of Embodiments 13-17, wherein the film comprises a polymeric material and the polymeric material of the film is the same polymeric material as the first polymeric material.

### Embodiment 19

The indicator panel of any of Embodiments 13-18, wherein the film is transparent, and wherein the image comprises a light transmitting ink and an opaque ink.

### Embodiment 20

A vehicle dashboard comprising the indicator panel of any of Embodiments 1-19.

Unless otherwise specified herein, any reference to standards, testing methods and the like, such as ASTM D1003, ASTM D3359 refer to the standard, or method, that is in force at the time of filing of the present application.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/we claim:

1. A method of manufacturing comprising:
introducing a first polymeric material to a mold, wherein the first polymeric material resists metallization;
introducing a second polymeric material to the mold, wherein the second polymeric material accepts metallization;
molding an article from the first polymeric material and the second polymeric material, wherein the second polymeric material extends along a surface portion of the article;
coupling a metallic material to the surface portion of the article to form a part having a metallic surface finish by exposing the article to the metallic material in a metallizing process, wherein the metallic material is not coupled to the first polymeric material.

2. A vehicle component formed by the method of claim 1.

3. The vehicle component of claim 2, wherein the vehicle component is chosen from a grille, a door handle, an interior trim component, an exterior trim component, a component of an indicator panel, a component of a dashboard display, a component of a gear shifter, a component of a console, a glove compartment handle, a vehicle logo, a vehicle badge, a vehicle emblem, a fascia, a hubcap, an antenna cover, a light surround, a light reflector, or a combination comprising at least one of the foregoing.

4. A method of manufacturing comprising:
applying an ink to a back side of a film to create an image;
placing the film into a mold;
forming a face plate shape into an area of the film having at least a portion of the image;
forming a registration feature into the film or applying a registration feature onto the film;
aligning the image with a protrusion by using the registration feature to position the film in a mold;
molding a polymeric material adjacent to the back side of the film to form an indicator panel, wherein the polymeric material covers at least a portion of the image and forms the protrusion on the front side of the film, wherein the protrusion aligns with the image.

5. The method of claim 4, wherein molding comprises pushing a portion of the film from the back side of the film with the polymeric material to form the protrusion.

6. The method of claim 4, comprising forming a hole through the film.

7. The method of claim 4, wherein forming the registration feature comprises indenting the film, wherein the registration feature can be used to position the film in a processing tool.

8. The method of claim 4, wherein applying the ink comprises screen printing, pad printing, membrane image transfer printing, transfer printing, ink jet printing, robotic dispensing, spraying, offset printing, sublimation printing, digital printing, or a combination of at least one of the foregoing.

9. The method of claim 4, wherein applying the ink comprises applying the ink to a side of the film while the film is flat.

10. The method of claim 4, wherein applying the ink comprises applying the ink to the front side of the film.

11. The method of claim 4, wherein forming a face plate shape further comprises forming two or more face plate shapes.

12. The method of claim 4, comprising exposing the indicator panel to a metallic material in a metallization process to couple the metallic material to a portion of a surface of the indicator panel.

13. An indicator panel comprising:
a film having a front side and a back side;
an ink disposed on the back side of the film, wherein the ink forms an image;
a face plate shape formed into an area of the film having at least a portion of the image;
a first polymeric material disposed adjacent to the back side of the film and covering at least a portion of the image; and
a protrusion extending from the front side of the film, wherein the protrusion comprises the polymeric material.

14. The indicator panel of claim 13, wherein the first polymeric material is disposed only on the back side of the film.

15. The indicator panel of claim 13, comprising a hole through the film, and wherein the protrusion extends through the hole in the film, and wherein the protrusion consists of the first polymeric material.

16. The method of claim 15, wherein the hole has the shape of a scale mark and/or a character.

17. The indicator panel of claim 13, further comprising a hole through the indicator panel and a movement mechanism extending through the hole in the indicator panel, wherein a pointer is in mechanical communication with the movement mechanism such that the pointer can be moved adjacent to the front side of the film.

18. The indicator panel of claim 13, wherein the film comprises a polymeric material and the polymeric material of the film is the same polymeric material as the first polymeric material

19. The indicator panel of claim 13, wherein the film is transparent, and wherein the image comprises a light transmitting ink and an opaque ink.

20. A vehicle dashboard comprising the indicator panel of claim 1.
